(19) United States
(12) Patent Application Publication
(10) Pub. No.: US 2013/0137029 A1
(43) Pub. Date: May 30, 2013

(54) TONER FOR ELECTROSTATIC IMAGE DEVELOPMENT AND IMAGE FORMING METHOD

(71) Applicants: Futoshi KADONOME, Tokyo (JP); Yasuhiko MURAMATSU, Tokyo (JP); Saburou HIRAOKA, Tokyo (JP)

(72) Inventors: Futoshi KADONOME, Tokyo (JP); Yasuhiko MURAMATSU, Tokyo (JP); Saburou HIRAOKA, Tokyo (JP)

(21) Appl. No.: 13/687,821

(22) Filed: Nov. 28, 2012

(30) Foreign Application Priority Data
Nov. 30, 2011 (JP) 2011-261633

(51) Int. Cl. G03G 9/08

(52) U.S. Cl. CPC G03G 9/08
USPC 430/105; 430/125.31

(57) ABSTRACT

Disclosed are a toner for electrostatic image development which is able to realize enough charge stability over a long period of time as deterioration of a toner due to mechanical stress is prevented in a developing unit, and to prevent generation of filming, and an image forming method using the same.

The toner for electrostatic image development contains toner particles and an external additive. The external additive includes silica fine particles whose surface is covered with a number of projections, and a number average particle diameter of the silica fine particles is 80 to 200 nm. The external additive may include small-diameter fine particles for external additive having a number average particle diameter of 5 to 45 nm.

### TECHNICAL FIELD

The present invention relates to a toner for electrostatic image development and an image forming method using the same.

### BACKGROUND ART

Recently, there is a need for energy-saving electrophotographic image forming apparatuses. In response to this, the so-called low-temperature fixing toners that is capable of being fixed at lower temperatures than those of conventional toners have been developed actively.

When the low-temperature fixing toners are used in image forming apparatuses for high speed, mass-printing, however, the toners are vulnerable to mechanical stress because toner particles themselves, constituting the low-temperature fixing toners, are configured to soften, easily. Also, the large mechanical stress applied in a developing unit causes significant deterioration of the toners, including embedding of external additives in the toner particles. This results in a reduction in a charge level of the toners and generation of image defects such as fogging in formed images.

In order to prevent the deterioration of the toners, it is known to add external additives of spherical-shaped and large-diameter fine particles as the external additives (see, for example, Patent Literature 1). As a spacer effect is exhibited in the developing unit by such large-diameter fine particles of the external additives, the embedding of the external additives in the toner particles can be prevented even when the mechanical stress is applied thereto, and therefore it is possible to obtain enough charge stability over a long period of time. As a result of this, the generation of the fogging can be prevented in the obtained images. In such a toner added with the spherical-shaped and large-diameter fine particles of the external additives, it is also known that blocking resistance is improved due to reduced non-electrostatic adhesion, and that behavior stability of a cleaning blade can be improved because the spherical-shaped particles roll at the tip of the cleaning blade to exhibit a lubricant effect (see, for example, Patent Literatures 1 and 2).

Meanwhile, when an image is actually formed by using the low-temperature fixing toner, the toner particles are brought into slidable contact between the tip of the cleaning blade and a photosensitive element, which may result, in generation of filming on the photosensitive element.

In particular, the photosensitive element has been ruggedized recently as one of studies to high durable materials (see, for example, Patent Literature 3). Such a photosensitive element with improved durability is designed to have a hard protective layer to suppress the reduced amount due to wear, and therefore a refreshing effect due to scraping of its surface is reduced. This tends to generate the filming easily when the low-temperature fixing toner is used.

According to the toners disclosed in the above-described Patent Literatures 1 and 2, however, it is not possible to sufficiently prevent the generation of such filming on the photosensitive element.

### CITATION LIST

### Patent Literature

Patent Literature 1: Japanese Patent Application Laid-Open No. 2007-99582
Patent Literature 2: Japanese Patent Application Laid-Open No. 2005-4051
Patent document 3: Japanese Patent Application Laid-Open No. 2011-186117

### SUMMARY OF INVENTION

### Technical Problem

The present invention has been made in view of the foregoing circumstances, and has as its object the provision of a toner for electrostatic image development which is able to realize enough charge stability over a long period of time as deterioration of a toner due to mechanical stress is prevented in a developing unit, and to prevent generation of filming, and an image forming method using the same.

### Means of Solving the Problem

According to the present invention, there is provide a toner for electrostatic image development containing toner particles and an external additive, wherein the external additive includes silica fine particles whose surface is covered with a number of projections, and a number average particle diameter of the silica fine particles is 80 to 200 nm.

In the toner for electrostatic image development according to the present invention, it is preferable that the silica fine particles whose surface is covered with a number of projections have surface roughness of 1.9 to 4.0.

In the toner for electrostatic image development according to the present invention, the external additive may include small-diameter fine particles for external additive having a number average particle diameter of 5 to 45 nm.

In the toner for electrostatic image development according to the present invention, the small-diameter fine particles for external additive may preferably be titania.

In the toner for electrostatic image development according to the present invention, the small-diameter fine particles for external additive may preferably be titania and silica.

In the toner for electrostatic image, development according to the present invention, an addition amount of the silica fine particles whose surface is covered with a number of projections may preferably be 0.5 to 4 parts by mass per 100 parts by mass of toner particles.

In the toner for electrostatic image development according to the present invention, an addition amount of the small-diameter fine particles for external additive may preferably be 0.1 to 5 parts by mass per 100 parts by mass of toner particles.

In the toner for electrostatic image development according to the present invention, a mass ratio between the silica fine particles whose surface is covered with a number of projections and the small-diameter fine particles for external additive (the silica fine particles whose surface is covered with a number of projections/the small-diameter fine particles for external additive) may preferably be 3/0.3 to 0.3/3.

In the toner for electrostatic image development according to the present invention, sphericity SF-1 of the silica fine particles whose surface is covered with a number of projections may preferably be 1.1 to 1.3.

According to the present invention, there is provided an image forming method including a toner image forming step of forming a toner image by developing an electrostatic latent image formed on an image carrier by a toner, a transferring step of transferring the toner image formed on the image carrier to a transfer material, and a cleaning step of removing the toner remaining on the image carrier after the transferring step by a cleaning blade provided with its tip coming in contact with the image carrier. The above-described toner for electrostatic image development is used as the toner.

In the image forming method according to the present invention, the image carrier may comprise an organic photosensitive element formed by laminating an organic photosensitive layer and a protective layer made of a cured resin on a conductive support in this order, wherein

the protective layer is obtained by curing a coating film of a coating liquid for forming protective layer that contains a polymerizable compound to form the cured resin constituting the protective layer and fine particles of a metal oxide.

### Advantageous Effects of Invention

The toner for electrostatic image development according to the present invention (hereinafter also simply referred to as a “toner”) contains specific silica fine particles. As the specific silica fine particles basically have the large diameter, the spacer effect is exhibited in the developing unit. Therefore, even, when the small-diameter fine particles for external additive are included, the embedding thereof into the toner particles can be prevented although the mechanical stress is applied thereto. Also, as the surface is covered with a number of projections, points of contact with the surf one of the toner particles increase and desorption from the toner particles hardly occurs as compared with spherical-shaped particles, resulting in an increase in durability. This makes it possible to obtain the enough charge stability over a long period of time and to prevent the generation of the fogging in the obtained images.

Moreover, as the specific silica fine particles have the large diameter and the surface covered, with a number of projections, its property to polish the photosensitive element is excellent. Thus, cleaning is performed in an excellent manner, and therefore the generation of the filming can be prevented.

### BRIEF DESCRIPTION OF DRAWINGS

FIG. 1 is a SEM photograph illustrating external appearance of silica fine particles included in a toner of the present invention;

FIG. 2 is an explanatory cross-sectional view illustrating an example of the structure of an image forming apparatus to carry out an image forming method of the present invention; and

FIG. 3 is an explanatory cross-sectional view illustrating an example of the structure of cleaning means of the image forming apparatus shown in FIG. 2.

### DESCRIPTION OF EMBODIMENTS

The present invention will hereinafter be described specifically.

### [Toner]

A toner for electrostatic image development of the present invention includes toner particles that contain at least a binder resin and that are externally added, with silica fine particles whose number average particle diameter is 80 to 200 nm and whose surface is covered with a number of projections (hereinafter referred to as “specifically-shaped silica fine particles”).

As the specifically-shaped silica fine particles are formed by silica whose refractive index is about 1.5, it is possible to minimize influences such as a reduction in transparency due to light scattering, even though the number average particle diameter is 80 to 200 nm. This is preferable because no influence is exerted on coloring and the like of a toner image.

The toner particles constituting the toner of the present invention may contain a colorant or an internal additive such as a release agent, a charge controlling agent and the like, if necessary.

### [External Additives]

### (Specifically-Shaped Silica Fine Particles)

The specifically-shaped, silica fine particles according to the present invention are the silica fine particles whose surface is covered with a number of projections. The projections exist over the entire surface to the extent that, when the specifically-shaped silica fine particles are brought into contact with a solid, object, the projections are always in contact with the solid object. Each projection may preferably be projected on the surface of the silica fine particle in a hemispherical shape.

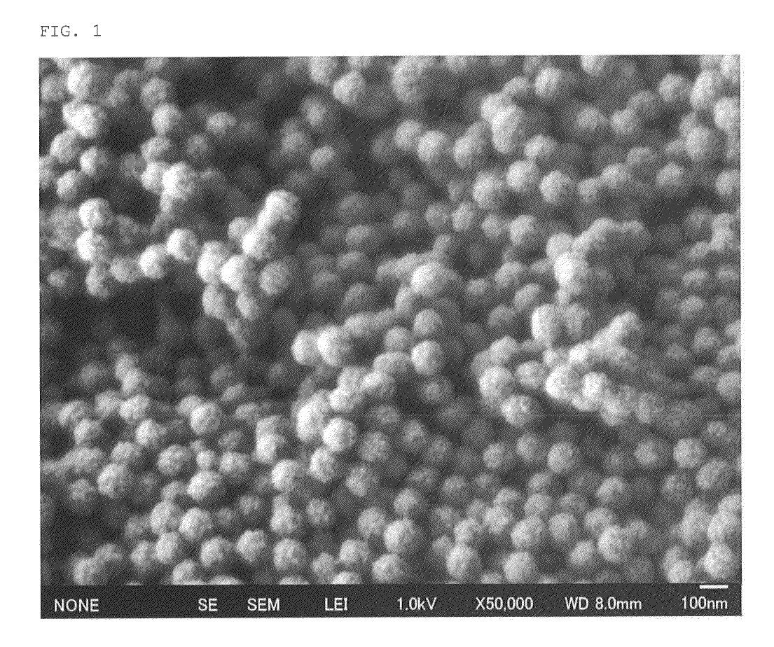

As shown in a SEM photograph of FIG. 1, it is preferable that the projections have the size of approximately 10 to 30 nm with respect to the particle of 80 to 200 nm.

It is preferable that the specifically-shaped silica fine particles have surface roughness within a range of 1.9 to 4.0, and sphericity within a range of 1.1 to 1.3.

It should be noted that the so-called spherical-shaped silica fine particles have the surface roughness lower than 1.9, and the sphericity of 1.0 to 1.3.

### [Surface Roughness]

The specifically-shaped silica fine particles included in the toner of the present invention may preferably have the surface roughness represented by (a BET specific surface area (SA1))/(a specific surface area (SA2) converted from a number average particle diameter (D)) within a range of 1.9 to 4.0, particularly within a range of 2.0 to 3.5.

The surface roughness is an index of an area constituted by the projections on the surface of the specifically-shaped silica fine particle. There are tendencies that the index increases as a surface area of the specifically-shaped silica, fine particle increases, that is, as the number of the projections increases and/or a size of each projection, increases, and that an index value decreases and approaches 1 as the surface area of the specifically-shaped silica fine particle is small, that is, the number of the projections decreases and the surface becomes smoother.

When, the surface roughness of the specifically-shaped silica fine particle is lower than 1.9, its shape becomes nearly spherical because the number of the projections is small or the size of each projection is too small with respect to a particle diameter of the specifically-shaped, silica fine particle. This makes it difficult to obtain an enough property to polish a photosensitive element, and an enough effect of preventing generation of filming. When the surface roughness of the specifically-shaped silica fine particle is more than 4.0, a cleaning blade may be damaged because its polishing force is too strong.

The specific surface area (SA2) converted, from the number average particle diameter (D) can be calculated using a following formula (1):

D=6000/(ρ×SA2) Formula (1)

In the formula (1), ρ is a density of the silica, [g/cm³], which is specifically 2.2.

It can be said that the value of the specific surface area (SA2) converted from the number average particle diameter (D) of the specifically-shaped silica fine particles corresponds to the specific surface area of the spherical-shaped silica fine particles having the number average particle diameter (D).

Further, the BET specific surface area (SA1) of the specifically-shaped silica fine particle is the specific surface area calculated from an adsorption amount of gas (typically nitrogen gas) to the specifically-shaped silica fine particle, and is the surface area corresponding to an actual state of the surface of the specifically-shaped silica fine particle.

### [Sphericity]

The specifically-shaped silica fine particle according to the present invention has a globular shape formed by a smooth curved surface including respective apexes of the projections, and is not the so-called deformed particle such as a rod shape, comma shape, slender shape, moniliform shape, egg shape and the like.

It is preferable that sphericity SF-1 of the specifically-shaped silica fine particle, calculated by a following formula (SF-1), falls within a range of 1.1 to 1.3. The sphericity SF-1 shows a degree of roundness, and the shape is closer to spherical as the sphericity approaches 1.0. When the specifically-shaped silica fine particle has the sphericity within the above range, it is likely that the specifically-shaped silica fine particle becomes globular in shape.

When the sphericity SF-1 is larger than 1.3, the silica, fine particle is not globular in shape and may be the deformed particle.

={(maximum diameter)²/(projection area)}×(π/4) Formula (SF-1)

Where, the maximum diameter means a maximum, interval between parallel two lines when a projection image of the specifically-shaped silica fine particle projected on a plane surface is sandwiched by the two parallel lines. Further, the projection area means the area of the projection image of the specifically-shaped silica fine particle projected on the plane surface.

The specifically-shaped silica fine particle is photographed at 250,000 magnification using a transmission electron microscope “H-800” (manufactured by Hitachi, Ltd.), and then the photographed image is scanned, by a scanner and subjected to binarization processing with regard to the specifically-shaped silica fine particle by an image processing analyzer “LUZEX AP (manufactured by Nireco Corporation),” to obtain the projection image of the specifically-shaped, silica fine particle. The projection area is an average value of 100 projection images.

### [Number Average Particle Diameter]

It is preferable that the specifically-shaped silica fine particles according to the present invention have the number average particle diameter of 80 to 200 nm, more preferably 100 to 150 nm.

When the number average particle diameter of the specifically-shaped silica fine particles falls within the above range, a spacer effect is exhibited by the specifically-shaped silica fine particles in a developing unit. Thus, even, when small-diameter fine particles for external additives are included, embedding thereof into the toner particles can be prevented, as a result of which a stable charge level can be obtained over a long period of time, and generation of fogging in the obtained images can be prevented.

Meanwhile, when the number average particle diameter of the specifically-shaped silica fine particles is lower than 80 nm, non-electrostatic adhesion, is not reduced sufficiently, and the embedding of the external additives into the toner particles cannot be prevented sufficiently because the spacer effect is not exhibited enough. When the number average particle diameter of the specifically-shaped silica fine particles is more than 200 nm, desorption from the toner particles easily occurs in the developing unit, resulting in a reduction in the charge level of the toner and the embedding of the fine particles of the external additives into the toner particles.

It should be noted that particle size distribution of the specifically-shaped silica fine particles may preferably be 22% or lower in a CV value. The CV value is calculated by a following formula (CV) using standard deviation in number-based particle size distribution and the value of the number average particle diameter.

CV value(%)=((standard deviation)/(number average particle diameter))×100 Formula (CV)

The number average particle diameter (D) of the specifically-shaped silica fine particles is measured by an image analysis method.

Specifically, the toner is photographed at 30,000 to 50,000 magnification using a scanning electron microscope, and then the photographed image is scanned by a scanner and subjected to the binarization processing with regard to the external additives existing on the surface of the toner particles in the photographed image using the image processing analyzer “LUZEX AP (manufactured by Nireco Corporation).” Then, Feret diameter in a parallel direction is calculated for 100 specifically-shaped silica fine particles that are arbitrarily selected, and the average value thereof is regarded as the number average particle diameter.

### (Production Process of Specifically-Shaped Silica Fine Particle)

The specifically-shaped silica fine particle according to the present invention can be manufactured using a spherical-shaped silica fine particle as a starting material.

Specifically, the spherical-shaped silica fine particle is obtained by a sol-gel method using alkoxysilane as a raw material (hereinafter also referred to as a “base silica fine particle”), and is made to react with a trifunctional silane compound to cause hydrolysis over an area not covering its entire surface. Here, the trifunctional silane compound includes one organic group having extremely low reactivity and three hydrolyzable groups such as an alkoxy group. Therefore, when the hydrolysis is caused by the trifunctional silane compound, the organic group of the trifunctional silane compound is bonded to a silanol group on the surface of the base silica fine particle, resulting in the state where an organosilyl group such as an alkylsilyl group exists on part of the surface of the base silica fine particle. Hereinafter, the base silica fine particle having the organosilyl group on part of its surface is referred, to as an “organized silica fine particle”.

Next, tetraethoxysilane is made to react to cause the hydrolysis with the silanol group remaining on the surface of the organized silica fine particle, so that the surface of the organized silica fine particle is partially built up. Thus, a silica sol is prepared in which the specifically-shaped silica fine particles, whose surface is covered with a number of projections, are dispersed in a solvent.

Then, hydrophobic treatment is performed to hydrophobize the surface of the silica fine particle by a hydrophobic treatment agent. The solvent is removed from the silica sol having been subjected to the hydrophobic treatment, and the silica sol is dried and sieved, to obtain the specifically-shaped silica fine particle according to the present invention. It is also possible that the thus-obtained specifically-shaped silica fine particle is subjected to the hydrophobic treatment again.

As the hydrophobic treatment agent, it is possible to use a commonly-used water-soluble silane compound.

As the water-soluble silane compound, a compound represented by a following general formula (1) can be used.

RₐSiX₄₋ₐ General formula (1)

[wherein R is a hydrogen atom or an organic group such, as an alkyl group or an alkenyl group, X is a chlorine atom or a hydrolyzable group such as a methoxy group or an ethoxy group, and a is an integer of from 0 to 3.]

Specifically, as examples of the compound represented by the general formula (1), may be mentioned methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltrimethoxysilane, decyltrimethoxysilane, hexamethyldisilazane, N,O-(bistrimethylsilyl)acetamide, N,N-bis(trimethylsilyl)-urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimetoxysilane, γ-glycidoxypropyltrimethoxysilane, γ-glycidoxypropylmethyldiethoxysilane, γ-mercaptopropyltrimethoxysilane, and γ-chloropropyltrimethoxysilane.

Among these, it is particularly preferable to use dimethyldimethoxysilane, hexamethyldisilazane, methyltrimethoxysilane, isobutyltrimethoxysilane and decyltrimethoxysilane.

The amount of the specifically-shaped silica fine particles to be added to the toner particles may preferably be 0.5 to 4 parts by mass, more preferably 1 to 3 parts by mass per 100 parts by mass of the toner particles.

When the amount of the specifically-shaped silica fine particles to be added to the toner particles is lower than 0.5 parts by mass, the non-electrostatic adhesion cannot be reduced sufficiently and effects of improving development and transfer cannot be obtained sufficiently. Meanwhile, when the amount of the specifically-shaped silica fine particles to be added to the toner particles is more than 4 parts by mass, the specifically-shaped silica fine particles are migrated from the surface of the toner particles to a contact member, which is likely to cause a secondary problem.

### (Small-Diameter Fine Particles for External Additive)

In the toner according to the present invention, it is preferable to use in combination the specifically-shaped silica fine particles and small-diameter fine particles for an external additive, having the number average particle diameter of 5 to 45 nm, more preferably 7 to 35 nm, as external additives, from the viewpoint of stabilizing charging ability and flowability over a long period of time. For such small-diameter fine particles for external additive, particularly, fine particles of silica, titania (rutile type, anatase type, and amorphous type), metatitanic acid, or alumina, silica/titania/alumina-based complex oxides may preferably be used. These small-diameter fine particles for external additives may be used either singly or in any combination thereof.

Among these, it is preferable to use the specifically-shaped silica fine particles and the titania fine particles in combination as the external additives of the toner of the present invention, from the viewpoint of environmental stability of the charge level of the toner.

The number average particle diameter of the small-diameter fine particles for external additive is measured similarly to the number average particle diameter of the specifically-shaped silica fine particles.

It should be noted that, when the number-based particle size distribution has a plurality of peaks, it is determined that there are a plurality of species in the fine particles of the external additives, and respective average particle diameters are calculated by dividing overlapping particle diameter portions so that the peaks correspond to those of normal distributions.

As examples of the small-diameter fine particles for external additive, may be mentioned, fine particles of various carbides such as silicon carbide, boron carbide, titanium carbide, zirconium carbide, hafnium carbide, vanadium carbide, tantalum carbide, niobium carbide, tungsten carbide, chromium carbide, molybdenum carbide, calcium carbide and diamond carbon lactam; various nitrides such as boron nitride, titanium nitride and zirconium nitride; borides such as zirconium boride; various oxides such as iron oxide, chromium oxide, titanium oxide, calcium oxide, magnesium oxide, zinc oxide, copper oxide, aluminum oxide, complex oxides formed by silica, silica/titania, alumina and the like by a gas phase method, and colloidal silica; various oxides such as calcium titanate, strontium titanate and magnesium titanate; sulfides such as molybdenum disulfide; fluorides such as magnesium fluoride and fluorocarbon; various metallic soaps such as aluminum stearate, calcium stearate, zinc stearate and magnesium stearate; and various nonmagnetic inorganic materials such as talc and bentonite. These may be used either singly or in any combination thereof.

It is preferable that such small-diameter fine particles for external additive are subjected to surface treatment by a publicly known method using hydrophobic treatment agents such as a silane-based coupling agent, a titanate-based coupling agent, a silicone-based oil and a silicone varnish that have been used conventionally, and also treatment agents such as a fluorine-based silane coupling agent, a fluorine-based silicone oil, an amino group/quaternary ammonium, salt containing coupling agent, a modified silicone oil and the like. It is possible to use various organic fine particles such as styrene-based ones, (meth)acrylic-based ones, benzoguanamine, melamine, Teflon (registered trademark), silicone, polyethylene, polypropylene and other organic fine particles that are formed by a wet polymerization method such as an emulsion polymerization method, a soap-free emulsion polymerization method, a nonaqueous dispersion polymerization method and the like, or a gas phase method.

The amount of the small-diameter fine particles for external additive to be added to the toner particles may preferably be 0.1 to 5.0 parts by mass, more preferably 0.4 to 4.0 parts by mass per 100 parts by mass of the toner particles.

When the added amount of the small-diameter fine particles for external additive is too small, desired charge characteristics and flow characteristics may not be reliably obtained. When the added amount of the small-diameter fine particles for external additive is too large, on the other hand, the fine particles of the external additive cannot be held on the surface of the toner particles any more, and may be desorbed from the surface of the toner particles to produce a side effect including charging failure and the like.

It is preferable that the toner of the present invention has a mass ratio between the specifically-shaped silica fine particles and the small-diameter fine particles for external additive (the specifically-shaped silica fine particles/the small-diameter fine particles for external additive) of 3/0.3 to 0.3/3.

### (Other Large-Diameter Fine Particles of External Additive)

In the toner of the present invention, it is also possible to use the specifically-shaped silica fine particles and other large-diameter fine particles of the external additive in combination, as the external additives.

### [Binder Resin]

The binder resin contained in the toner particles constituting the toner of the present invention may be publicly known various resins such as styrene-based resins, (meth)acrylic-based resins, styrene-(meth)acrylic-based, resins, vinyl-based, resins such as olefin-based resins, polyester-based resins, polyamide-based resins, polycarbonate resins, polyether, polyvinyl acetate-based resins, polysulfone, epoxy resins, polyurethane resins, urea resins and the like. It is especially preferable to use the styrene-acrylic-based resins and the polyester-based resins, because the toner with excellent low temperature fixability can be obtained therefrom. These resins may be used either singly or in any combination thereof.

### [Colorant]

When the colorant is contained in the toner particles according to the present invention, generally known dyes and pigments may be used as the colorant.

As the colorant to obtain a black toner, various types of known colorants may be arbitrarily used including carbon black such as furnace black and channel black, magnetic materials such as magnetite and ferrite, dyes, inorganic pigments such as a nonmagnetic iron oxide, and the like.

As the colorant to obtain colored toners, known dyes and organic pigments may be arbitrarily used. Specifically, as examples of the organic pigments, may be mentioned C. I. Pigment Red 5, 48:1, 53:1, 57:1, 81:4, 122, 139, 144, 149, 166, 177, 178, 222, 238, and 269, C. I. Pigment Yellow 14, 17, 74, 33, 94, 138, 155, 180, and 185, C. I. Pigment Orange 31 and 43, and C. I. Pigment Blue 15; 3, 60, and 76. As examples of the dyes, may be mentioned C. I. Solvent Red 1, 49, 52, 58, 68, 11, and 122, C. I. Solvent Yellow 19, 44, 77, 79, 81, 82, 93, 98, 103, 104, 112, and 162, and C. I. Solvent Blue 25, 36, 69, 70, 93, and 95.

The colorants to obtain the various colored toners may be used either singly or in any combination thereof for each of the colors.

The content of the colorant may preferably be 1 to 10 mass %, more preferably 2 to 8 mass % in the toner particles.

### [Release Agent]

When a release agent is contained as the internal additive in the toner particles according to the present invention, known waxes may be used as the release agent, examples of which is may include hydrocarbon-based waxes such as a low-molecular weight polyethylene wax, a low-molecular weight polypropylene wax, a Fischer-Tropsch wax, a micro crystalline wax, and a paraffin wax; and ester waxes such as a carnauba wax, pentaerythritol behenic acid ester, behenyl behenate, and behenyl citrate. These waxes may be used either singly or in any combination thereof.

The content of the release agent may preferably be 2 to 20 parts by mass, more preferably 3 to 18 parts by mass per 100 parts by mass of the binder resin.

### [Charge Controlling Agent]

When a charge controlling agent is contained as the internal additive in the toner particles according to the present invention, known charge controlling agents can be used as the charge controlling agent, examples of which may include a nigrosine dye, a metallic salt of naphthenic acid or higher fatty acid, alkoxylated amine, a quaternary ammonium salt compound, an azo-based metal complex, a metal salt or metal complex of salicylic acid, and a calixarene compound. They may be used either singly or in any combination thereof.

The content of the charge controlling agent may preferably be 0.1 to 3.0 parts by mass, more preferably 0.1 to 1.0 parts by mass per 100 parts by mass of the binder resin.

The average particle diameter of the toner may preferably be 3 to 8 μm, more preferably 5 to 8 μm, for example, in terms a volume-based median diameter. The average particle diameter can be controlled by concentration of an aggregating agent used at the time of manufacturing, an addition amount of an organic solvent, fusing time, composition of the binder resin and the like.

When the volume-based median diameter falls within the above range, extremely small dot images at the level of 1,200 dpi can be reproduced precisely.

The volume-based median diameter of the toner is measured and calculated using a measuring device composed of “Multisizer 3” (manufactured by Beckman Coulter, Inc.) and a computer system connected thereto and equipped with data processing software “Software V3.51,” Specifically, 0.02 g of the toner is added to and mixed thoroughly and evenly with 20 mL of a surfactant solution (for example, a surfactant solution in which, a neutral detergent containing a surfactant component is diluted with pure water by 10 times, for the purpose of dispersing the toner particles) and subjected to ultrasonic dispersion for one minute to prepare a dispersion liquid of the toner. This toner dispersion liquid is added with a pipette into a beaker held in a sample stand, in which “ISOTON II” (manufactured by Beckmann Coulter, Inc.) is contained, until the concentration displayed on the measuring device reaches 8%. By employing this concentration range, a reproducible measurement value can be obtained. The number of particles to be counted is set to 25,000 and the aperture diameter is set to 100 μm in the measuring device. The range of measurement of 2 to 60 μm is divided into 256 sections, and a frequent value in each section is calculated. The particle diameter when a cumulative volume fraction cumulated from the largest volume fraction is 50% is used as the volume-based median diameter.

In the toner of the present invention, it is preferable that the coefficient of variation (CV value) in the particle size distribution of the volume-based median diameter of the toner is 30% or lower, more preferably 25% or lower.

When the coefficient of variation (CV value) of the toner falls within the above range, the toner particles are equal to each other in size. This makes it possible to reproduce fine dot images and fine lines with higher accuracy, and to reduce an amount of the toner not contributing to fixing after fixing pressure is uniformly applied to the toner during a fixing process.

The coefficient of variation (CV value) in the particle size distribution of the volume-based median diameter is calculated by a following formula (CV). A reduction in this CV value means that the particle size distribution is sharp and that the toner particles are equal to each other in size.

CV value(%)=the standard deviation in the particle size distribution/the median diameter in the particle size distribution×100 Formula (CV)

As to each of the toner particles constituting the toner, average circularity may preferably be 0.930 to 0.980, more preferably 0.940 to 0.970, from the viewpoints of stability in the charge characteristics and a cleaning property.

The average circularity of the toner particles is the value measured by using “FPIA-2100” (manufactured by Sysmex Corporation). Specifically, the toner is mixed thoroughly and evenly with an aqueous solution containing a surfactant, and subjected to the ultrasonic dispersion for one minute for dispersion. Thereafter, it is photographed by the “FPIA-2100” (manufactured by Sysmex Corporation) under the measurement conditions of an HPF (High Power Field) mode and at an appropriate concentration with an HPF detection number of 3,000 to 10,000. The circularity of each of the toner particles is calculated on the basis of a following formula (y), and the circularity of the respective toner particles are added and divided by the number of all the toner particles, to thereby calculate the value of the average circularity of the toner particles. When the HPF detection number falls within the above range, it is possible to obtain reproducibility.

circularity=(a perimeter of a circle having the same projection area as a particle image)/(a perimeter of the particle projection image) Formula (y)

The binder resin may preferably have a glass transition point of 35 to 70° C., more preferably of 45 to 55° C. Further, the binder resin may preferably have a softening point of 80 to 110° C., more preferably of 90 to 105° C.

The glass transition point of the binder resin is measured by using a differential scanning calorimeter “Diamond DSC” (manufactured by PerkinEimer Co., Ltd.).

Specifically, 3.0 mg of the toner that is enclosed in an aluminum pan and set in a holder is subjected to temperature control of Heat-cool-Heat, under the measurement conditions of measurement temperature of 0° C. to 200° C., a rate of temperature increase of 10° C./minute, and a rate of temperature decrease of 10° C./minute, while using an empty aluminum pan as a reference. Data of the second Heat is acquired, and an intersection between an extension line of a base line before a rise of a first endothermic peak and a tangential line indicating a maximum inclination from the rise of the first endothermic peak to its peak apex is shown as the glass transition point.

Further, the softening point of the binder resin is measured as follows.

Under the environment of 20° C. and 50% RH, 1.1 g of the binder resin is placed and flattened in a petri dish and allowed to stand for 12 hours. Thereafter, pressure of 3,000 kg/cm² is applied for 30 seconds by a molding device “SSP-10A” (manufactured by Shimadzu Corporation) to form a molded, sample in a cylindrical shape having a diameter of 1 cm. Next, a flow tester “CFT-500D” (manufactured by Shimadzu Corporation) is employed and, under the environment of 24° C. and 50% RH, the molded sample is extruded from a hole of a cylindrical die (1 mm diameter×1 mm) using a piston having a diameter of 1 cm after preheating, under the conditions of a load of 196 N (20 kgf), starting temperature of 60° C., preheating time of 300 seconds, and a rate of temperature increase of 6° C./minute. Then, offset method temperature T_{offset} measured by a melting temperature measurement method of a temperature rise method, with setting of an offset value of 5 mm, is regarded as the softening point of the binder resin.

### [Production Process of Toner Particles]

The toner of the present invention is formed by the toner particles added, with the external additives, and examples of the production process of the toner particles may include a kneading and pulverizing method, a suspension polymerization method, an emulsion aggregation method, a dissolution suspension method, a polyester extension method, and a dispersion polymerization method.

It is preferable to employ the emulsion aggregation method among these from the viewpoints of uniformity in a particle diameter that is advantageous to improve picture's quality and stability, shape controllability, and easiness of forming the core-shell, structure.

According to the emulsion aggregation method, the toner particles are manufactured by mixing a dispersion liquid, in which the resin fine particles are dispersed by the surfactant or dispersion stabilizer, with a dispersion liquid of a toner particle component such as the colorant fine particles as necessary, aggregating the particles by adding the aggregating agent until a desired diameter of the toner particles is obtained, and fusing the resin fine particles after or simultaneously with the aggregation to control the shape of the particles.

Here, the resin fine particles may optionally contain the internal additive such as the release agent or the charge controlling agent, or may be composite particles formed by a plurality of layers having two or more layers of resins differing in composition.

It is also preferable from the viewpoint of structural design of the toner to add a different kind of resin fine particles at the time of aggregation to obtain the toner particles having the core-shell structure.

The resin fine particles may be manufactured by, for example, the emulsion polymerization method, a miniemulsion polymerization method, a phase inversion emulsification method or the like, or a combination thereof. It is preferable to use the miniemulsion polymerization method among these, when, the internal additive is contained, in the resin fine particles.

The external additives including at least the specifically-shaped silica fine particles are added to the dried toner particles as obtained, by a dry process, thereby adding and mixing the external additives as powder. In this manner, the toner of the present invention is manufactured.

Known mixing devices such as a Henschel mixer and a coffee mill may be used as the mixing device of the external additives.

### [Developer]

The toner of the present invention may be used as a magnetic or non-magnetic one-component developer, but may also be mixed with a carrier to be used as a two-component developer by being. When the toner is used as the double-component developer, magnetic particles formed by conventionally known materials, such as metals including iron, ferrite, magnetite and the like and alloys or these metals and metals including aluminum, lead and the like, can be used as the carrier, and it is particularly preferable to use the ferrite particles. As the carrier, it is also possible to use a coated carrier that is the magnetic particles having a coating agent such as a resin coated on its surface, a dispersion type carrier that has fine powder of a magnetic substance dispersed in the binder resin, and the like.

The volume-based median diameter of the carrier may preferably be 20 to 100 μm, more preferably 25 to 80 μm. The volume-based median diameter of the carrier can be measured typically by a laser diffraction type particle size distribution measuring device “HELOS” (manufactured by Sympatec GmbH) equipped with a wet dispersion, device.

The preferable carriers include a resin coated carrier that is the magnetic particles having the resin coating on its surface, and the so-called resin dispersion type carrier that has the magnetic particles dispersed in the resin. Examples of the resin constituting the resin coated carrier may include olefin-based resins, styrene-based resins, styrene-acrylic-based resins, acrylic-based resins, silicone-based resins, ester-based resins, and fluorine-containing polymer-based resins, although not limited to the above. Further, the resin constituting the resin dispersion type carrier may be publicly known various resins, such as acrylic-based resins, styrene-acrylic-based resins, polyester-based resins, fluorine-based resins, and phenol resins, although not limited to the above.

As the toner of the present invention contains the specifically-shaped silica fine particles, which basically have the large diameter, the spacer effect is exhibited in the developing unit. Therefore, when, the toner includes the small-diameter fine particles for external additive, it is possible to prevent the embedding into the toner particles even when the mechanical stress is applied thereto. This makes it possible to obtain enough charge stability over a long period of time and to prevent the generation of the fogging in the obtained images.

Moreover, as the specifically-shaped, silica fine particles have the large diameter and have a number of projections covering the surface, its property to polish the photosensitive element is excellent. Thus, cleaning is performed in an excellent manner, and therefore generation of filming can be prevented.

### [Image Forming Method]

The toner of the present invention can be used preferably in an image forming method using an image forming apparatus equipped with a specific organic photosensitive element and cleaning means having a cleaning blade.

Further, the toner of the present invention, can be used preferably in an image forming method having relatively low fixing temperature (surface temperature of a fixing member) of 100 to 200° C.

Furthermore, the toner of the present invention can be used preferably in a high-speed machine having a linear velocity of the organic photosensitive element of 100 to 500 mm/sec.

Specifically, such an image forming method is an electrophotographic image forming method including a toner image forming step of forming a toner image by developing an electrostatic latent image formed on an image carrier by the toner, a transferring step of transferring the toner image formed on the image carrier to a transfer material, and a cleaning step of removing the toner remaining on the image carrier after the transferring step by a cleaning blade provided with its tip coming in contact with the image carrier.

Hereinafter, the electrophotographic image forming method using an image forming apparatus shown in FIG. 2 will be described specifically.

### [Image Forming Apparatus]

FIG. 2 is an explanatory cross-sectional view illustrating an example of the structure of the image forming apparatus to perform the image forming method of the present invention.

The image forming apparatus includes a toner image forming unit 10 that forms a toner image to be formed and transfers it onto a transfer material P, and a fixing device 20 that fixes the toner image by applying pressure to the transfer material P on which the toner image has been formed while heating it.

The toner image forming unit 10 includes a photosensitive element 15 as a rotating image carrier, charge means 11 that applies a uniform potential to the surface of the photosensitive element 15, exposure means 12 comprising a semiconductor laser beam source 12A, a polygon mirror 12B and an fθ lens 12C to form an electrostatic latent image having a desired shape on the uniformly charged photosensitive element 15, a developing unit 13 to develop the electrostatic latent image by carrying the toner onto the photosensitive element 15, transfer means 14 that transfers the toner image having been formed by the developing unit 13 onto the transfer material P, separation means 16 that separates the transfer material P onto which the toner image has been transferred from the photosensitive element 15, cleaning means 19 having a cleaning blade 19A formed by a rubber-like elastic body to collect the residual toner remaining on the photosensitive element 15 after the transferring, and precharge exposure means (PCL) 17.

The fixing device 20 is provided with a pair of heating and pressurizing rollers 21 and 22 that are in contact with each other by pressure and a nip N formed at a pressure-contact part thereof.

### [Cleaning Blade]

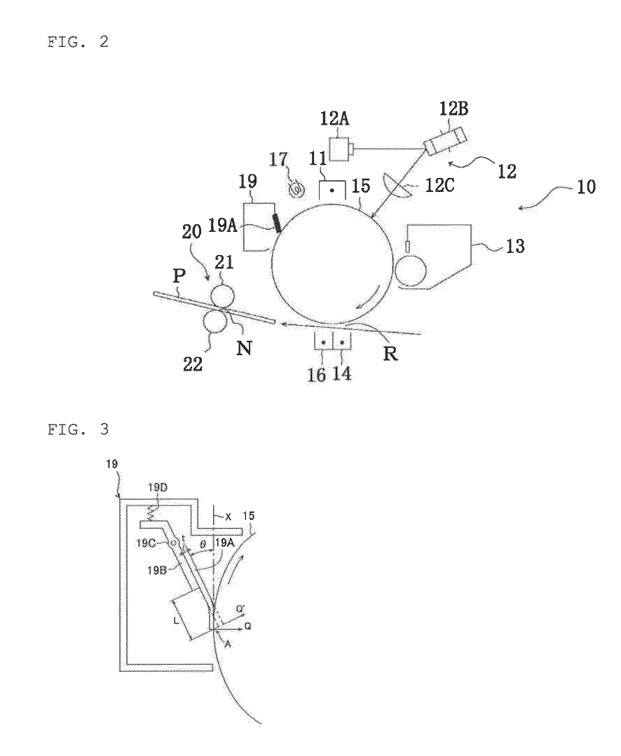

The cleaning blade 19A provided to the cleaning means 19, as shown in FIG. 3, is supported by a supporting member 19B at its base end, and the base end is provided to abut against the surface of the photosensitive element 15. The cleaning blade 19A extends from the base end side in a direction opposite to a rotational movement direction of the photosensitive element 15 at the abutment position, which is a so-called counter direction.

In FIG. 3, 19C denotes a rotation axis of the supporting member 19B, and 19D denotes a load spring.

It is preferable that a contact load Q of the cleaning blade 19A to the photosensitive element 15 is 5 to 40 N/m. When the contact load Q of the cleaning blade 19A to the photosensitive element 15 is smaller than 5 N/m, cleaning failure is likely to occur, and when the contact load Q of the cleaning blade 19A to the photosensitive element 15 is larger than 40 N/m, rubbing force of the cleaning blade against the surface of the photosensitive element is too strong, as a result of which striped image defects are likely to be generated in the obtained visible image as a reduced amount due to wear of the surface layer of the photosensitive element decreases by the use.

Also, a contact angle θ of the cleaning blade 19A to the photosensitive element 15 may preferably be 5 to 35°.

The contact load Q of the cleaning blade 19A to the photosensitive element 15 is a vector value in a normal direction of contact pressure Q′ when the cleaning blade 19A is made to abut against the photosensitive element 15. Further, the contact angle θ is the angle formed between a tangential line X and the cleaning blade 19A before being deformed (shown by dotted lines in FIG. 3) at the abutment position of the photosensitive element 15.

The contact load Q of the cleaning blade 19A is calculated by a spring constant and a displacement amount of the spring when using a spring load, and calculated by a weight of a load when using a weight load. When using other load methods, a load is directly measured by using a weight scale and the like.

A tree length L of the cleaning blade 19A is the length from the base end of the cleaning blade 19A in an area where it is not in contact with the supporting member 19B to the tip thereof before being deformed by application of the force, and may preferably be 3 to 15 mm.

Further, the thickness t of the cleaning blade 19A may preferably be 0.5 to 10 mm.

Examples of the generally used material of the elastic body constituting the cleaning blade 19A may include a urethane rubber, a silicone rubber, a fluorine-containing rubber, a chloroprene rubber, and a butadiene rubber. Among these, the urethane rubber is particularly preferable due to its excellent wear characteristics compared with other rubbers.

In order to control inversion associated with the use of the cleaning blade 19A, it is preferable to control hardness and impact resilience of the material of the elastic body constituting the cleaning blade 19A. Specifically, it is preferable to control JIS A hardness of the elastic body at the temperature of 25±5° C. to be 65 to 80, and the impact resilience to be larger than 20% and not more than 75%.

Here, the JIS A hardness and the impact resilience are measured by a physical testing method of a vulcanized rubber as specified in JIS K6301.

When the JIS A hardness of the elastic body at the temperature of 25±5° C. is smaller than 65, the inversion, of the cleaning blade easily occurs, and when it is larger than 80, the cleaning property is decreased. Further, when the impact resilience is larger than 75%, the inversion of the cleaning blade easily occurs, and when it is 20% or smaller, the cleaning property is decreased.

### [Organic Photosensitive Element]

The organic photosensitive element used in the image forming method of the present invention includes an organic photosensitive layer and a protective layer made of a cured resin, which are laminated on a conductive support in this order. The protective layer is obtained by curing a coating film of a coating liquid for forming protective layer that contains a polymerizable compound to form the cured resin constituting the protective layer and fine particles of the metal oxide.

The layer structure of the organic photosensitive element is not particularly limited as long as the organic photosensitive layer and the protective layer are laminated on the conductive support in this order. Specifically, the layer structure may be the following (1) or (2).

(1) The layer structure having an intermediate layer, a charge generation layer and a charge transport layer as the organic photosensitive layers, and the protective layer laminated on the conductive support in this order.
(2) The layer structure having the intermediate layer, a single layer including a charge generation substance and a charge transport substance as the organic photosensitive layer, and the protective layer laminated on the conductive support in this order.

According to the present invention, the organic photosensitive element is configured to exhibit at least one of charge generation function and charge transport function, which are essential to the structure of the electrophotographic organic photosensitive element, by an organic compound, and includes: an organic photosensitive element having an organic photosensitive layer formed by a known organic charge generation substance or a known organic charge transport substance, an organic photosensitive element having an organic photosensitive layer whose charge generation function and charge transport function are derived from a polymer complex, and all other known organic photosensitive elements.

It is possible to manufacture the organic photosensitive layer by conventionally-known various manufacturing methods using conventionally-known raw materials.

The protective layer in the organic photosensitive element used in the image forming method of the present invention is formed by: preparing the coating liquid for forming a protective layer by adding to a known solvent the polymerizable compound to form the cured resin constituting the protective layer, a polymerization initiator, metal oxide fine particles and, as necessary, a lubricant particle, an antioxidant or a resin other than the cured resin; applying the coating liquid for forming a protective layer to an outer peripheral surface of the organic photosensitive layer to form a coating film; and drying the coating film and irradiating with active rays such as ultraviolet rays, electron rays and the like to subject the polymerizable compound in the coating film to polymerization reaction for curing.

The organic photosensitive element having the protective layer formed by the cured resin has excellent wear resistance and durability as compared with the photosensitive element not having the protective layer formed by the cured resin. Meanwhile, as the surface of the photosensitive element having the protective layer formed by the cured resin is hardly scraped, the filming may be generated. However, by using the toner having the specifically-shaped silica fine particles according to the present invention together with the photosensitive element having the protective layer formed by the cured resin, a polishing effect is exhibited by the specifically-shaped silica fine particles to prevent the generation of the filming. This makes it possible to output images more stably over a longer period of time as compared with the conventional case.

The film thickness of the protective layer may preferably be 0.2 to 10 μm, more preferably 0.5 to 5 μm.

It is also possible to form the protective layer by using a known resin together with the cured resin.

As examples of the known resin, may be mentioned polyester resins, polycarbonate resins, polyurethane resins, acrylic resins, epoxy resins, silicone resins and alkyd resins,

### (Polymerizable Compound)

As example of the polymerizable compound to form the cured resin, may be mentioned a styrene-based monomer, an acrylic-based monomer, a methacrylic-based monomer, a vinyltoluene-based monomer, a vinyl acetate-based monomer, an N-vinyl pyrrolidone-based monomer and the like, although not limited to the above. These polymerizable compounds may be used either singly or in any combination thereof.

As the polymerizable compound can be cured with a small amount of light or in a short period of time, it is preferable that the polymerizable compound is formed by a compound having an acryloyl group (CH₂═CHCO—) or a methacryloyl group (CH₂═CCH₃CO—) as a polymerizable functional group.

### (Metal Oxide Fine Particles)

The coating liquid for forming protective layer contains the metal oxide fine particles for the purpose of adding higher durability to the formed protective layer.

Such metal oxide fine particles may be selected from the metal oxide fine particles including transition metals, and examples thereof may include silica (silicon oxide), magnesium oxide, zinc oxide, lead oxide, alumina (aluminum oxide), tin oxide, tantalum oxide, indium oxide, bismuth oxide, yttrium oxide, cobalt oxide, copper oxide, manganese oxide, selenium oxide, iron oxide, zirconium oxide, germanium oxide, titanium dioxide, niobium oxide, molybdenum oxide and vanadium oxide. Among these, the fine particles of alumina (Al₂O₃), tin oxide (SnO₂) and titanium dioxide (TiO₂) are preferable, and the fine particles of alumina and tin oxide are more preferable.

A number average primary particle diameter of the metal oxide fine particles may preferably fall within a range of 1 to 300 nm, more preferably 3 to 100 nm.

According to the present invention, the number average primary particle diameter of the metal oxide fine particles is measured as follows.

Magnified pictures at 10,000 magnification are photographed by a scanning electron microscope “JSM-7500F” (manufactured by JEOL Ltd.), and scanned picture images of 300 metal oxide fine particles that are randomly selected (except for agglomerates) are subjected to automatic image processing and analysis equipment “LUZEX AP” (software ver. 1.32, manufactured by Nireco Corporation) to calculate the number average primary particle diameter of the metal oxide fine particles.

Means for dispersing the metal oxide fine particles may be dispersion devices including, for example, an ultrasonic dispersion device, a ball mill, a sand grinder and a homomixer, although not limited to the above.

The content of the metal oxide fine particles may preferably be 20 to 400 parts by mass, more preferably 50 to 300 parts by mass per 100 parts by mass of the polymerizable compound.

When the content of the metal oxide fine particles is too low, electric resistance of the formed protective layer is reduced, which may cause a difficulty in preventing an increase in a residual potential and the generation of the fogging. Meanwhile, when the content of the metal oxide fine particles is too nigh, an excellent film formation property cannot be obtained in the protective layer to be formed, which may cause a difficulty in preventing a decrease in the charging ability and generation of pin holes.

Further, the metal oxide fine particles may preferably be subjected to the surface treatment by a surface treatment agent having the polymerizable functional group (hereinafter also referred to as a “polymerizable functional group containing surface treatment agent”). Particularly, alumina fine particles or tin oxide fine particles that are subjected to the surface treatment by the polymerizable functional group containing surface treatment agent are more preferable.

Such a polymerizable functional group containing surface treatment agent should have reactivity with a hydroxyl group or the like existing on the surface of the metal oxide fine particles and, specifically, the one having the acryloyl group or the methacryloyl group is preferable.

When the metal oxide fine particles are subjected to the surface treatment by the polymerizable functional group containing surface treatment agent, bonding with the polymerizable compound becomes strong, and higher durability of the formed protective layer is realized.

The image forming method is performed by thus-structured image forming apparatus as follows.

First, in the toner image forming unit 10, an electrostatic latent image is formed on the photosensitive element 15 by being charged by the charge means 11 and exposed by the exposure means 12, and the electrostatic latent image is developed in the developing unit 13 using the toner, to form a toner image.

Meanwhile, the transfer material P that is received in a not-shown paper cassette is timely carried to a transfer region R by not-shown carrying means, and at the transfer region R, the toner image on the photosensitive element 15 is transferred onto the transfer material P by the transfer means 14, and the transfer material P, on which the toner image has been transferred, is separated from the photosensitive element 15 by the separation means 16.

Next, the separated transfer material P is carried to the nip N in the fixing device 20 and at the nip N, the toner image is fixed by application of pressure and heat, whereby an image is formed.

Meanwhile, the residual toner remaining on the photosensitive element 15 after the transfer material P is separated therefrom is removed by the cleaning blade 19A of the cleaning means 19.

Specifically, an appropriate interruption layer is formed by the fine particles of the external additives between the tip of the cleaning blade 19A and the surface of the photosensitive element 15, and as a result of this, the residual toner is removed from the surface of the photosensitive element 15 by the interruption layer.

After transferring the toner image to the transfer material P, the photosensitive element 15 is used to form the next toner image, after the toner remaining on its surface is removed by the cleaning means 19 and the charge remaining thereon is removed by the precharge exposure means 17.

The embodiment of the present invention has been specifically described thus far, but the embodiment of the present invention is not limited to the above example, and can be modified in various ways.

### Example

Hereinafter, a specific example of the present invention will be described, but the present invention is not limited to this example. The number average particle diameter (D), the surface roughness and the sphericity of the specifically-shaped silica fine particles were measured as described above.

### Manufacturing Example 1 of Specifically-Shaped Silica Fine Particles

### (1) Manufacturing of Base Silica Fine Particles

A mixed solvent, in which 139.1 g of pure water and 169.9 g of methanol were mixed, was maintained at 65° C., and 2,982.5 g of a water-methanol solution of tetraethoxysilane “ethyl silicate 28” (manufactured by Tama Chemicals Co., Ltd., SiO₂=28 mass %) (2,450 g of a mixed solvent of water/methanol (mass ratio: 2/8) into which 532.5 g of tetraethoxysilane was dissolved), and 596.4 g of ammonia water having the concentration of 0.25 mass % as a catalyst (mol ratio of catalyst/alkoxysilane=0.034) were simultaneously added to the mixed solvent over 20 hours. After the addition, it was subjected to aging for three more hours at the same temperature.

After removing unreacted tetraethoxysilane, methanol and ammonia almost completely by using an ultrafilter membrane, it was purified by a both ion exchange resin and concentrated by the ultrafilter membrane, to obtain a dispersion liquid of base silica fine particles [1] having a solid component concentration of 20 mass %. The mass of the base silica fine particles [1] in the obtained dispersion liquid was 296 g. The number average particle diameter of the base silica fine particles [1] was 100 nm. The sphericity of the base silica fine particles [1] was 1.05.

### (2) Organizing of Base Silica Fine Particles by Methyltrimethoxysilane

Ammonia water having the concentration of 28% by mass was added as a hydrolysis catalyst to 4,000 g of an aqueous solution, in which the obtained base silica fine particles [1] were diluted to 7.4%, and the pH was controlled to 11.2. After heating this solution to 65° C., a mixed solution of 19.65 g of methyltrimethoxysilane (0.14 mol) as a trifunctional silane compound and 100.36 g of methanol were added thereto over 60 minutes. It was subjected to the aging for further one hour while maintaining its temperature at 65° C., to obtain 4,120 g of a dispersion liquid of the organized silica fine particles [1].

### (3) Repeated Particle Growth of Organized Silica Fine Particles by Tetraethoxysilane

1,500 g of the dispersion liquid of the organized silica fine particles [1] was sampled and the temperature thereof was maintained to 65° C. To this dispersion liquid, a mixed solution of 655.8 g of tetraethoxysilane (3.15 mol) and 1,245.1 g of methanol, and a mixed solution of 887.1 g of ultrapure water and 49.1 g of 28.6% ammonia water were added over 10 hours for hydrolysis. After the addition, it was subjected to the aging for three more hours while maintaining its temperature at 65° C. A number of moles of the used tetraethoxysilane was 1.47×10⁻⁴ per 1 m² surface area of the base silica fine particles. After removing unreacted tetraethoxysilane, methanol and ammonia almost completely by using the ultrafilter membrane, it was purified by a both ion exchange resin and concentrated by a rotary evaporator to obtain a silica sol having the solid component concentration of 12.6 mass %.

The obtained silica sol was subjected to the hydrophobic treatment using hexamethyldisilazane, dried and pulverized to obtain specifically-shaped silica fine particles [1] having the number average particle diameter (D) of 120 nm.

The number average particle diameter (D), the surface roughness, the sphericity and the CV value of the specifically-shaped silica fine particles [1] are shown in Table 1.

### Manufacturing Examples 2 to 4 of Specifically-Shaped Silica Fine Particles

Specifically-shaped silica fine particles [2] to [4] having average particle diameters shown in Table 1 were obtained in the same manner as in the manufacturing example 1 of the specifically-shaped silica fine particles, except that the addition amount of methylmethoxysilane, the addition amount of tetraethoxysilane, the aging time and the like were changed.

The number average particle diameter (D), the surface roughness, the sphericity and the CV value of the specifically-shaped silica fine particles [2] to [4] are shown in Table 1.

### Manufacturing Example 1 of Spherical-Shaped Silica Fine Particles

690 g of methanol, 26 g of water and 58 g of 25 mass % ammonia water were fed and mixed in a 3 L glass reactor equipped with a stirrer, a dropping funnel and a thermometer. While this solution was stirred and adjusted to 35° C., 1,200 g of tetramethoxysilane (7.88 mol) and 432 g of 5.4 mass % ammonia water were started to be added simultaneously and respectively dropped thereto over five hours. After the completion, of dropping, it was stirred for further 0.5 hours and subjected to the hydrolysis and condensation to obtain a mixed medium dispersion liquid [A] of hydrophilic spherical-shaped silica fine particles. At this time, the water content of the mixed medium dispersion liquid [A] was 16.1 mass % by gas chromatography analysis.

After 12 g of methyltrimethoxysilane (0.088 mol) was dropped to the mixed medium dispersion liquid [A] at room temperature over 0.5 hours, it was heated to 50° C. and made to react for one hour to subject the surface of the silica fine particles to the hydrophobic treatment. Thus, a mixed medium dispersion liquid [B] of the hydrophobic spherical-shaped silica fine particles was obtained.

Next, an ester adapter and a condenser tube were attached to the glass reactor, and the mixed medium dispersion liquid [B] was heated to 60 to 70° C. to distill off 345 g of the mixture of methanol and water. Then, while adding methylisobutylketone thereto, a mixture of methanol, waiter and methyl isobutyl ketone was simultaneously distilled off until the dispersion liquid became 115° C. At this time, the added, amount of methyl isobutyl ketone was 1.954 g, and the distilled amount was 1.954 g. After adding 150 g of hexamethyldisilazane (0.93 mol) to the obtained methyl isobutyl ketone dispersion liquid at the room temperature, the dispersion liquid was heated to 110° C. and made to react for three hours, thus trimethylsilylating the silica fine particles in the dispersion liquid. Next, the solvent in the dispersion liquid was distilled off at 80° C. and under reduced pressure (6.650 Pa), to obtain 466 g of hydrophobic spherical-shaped silica fine particles, which are referred to as spherical-shaped silica fine particles [5].

The number average particle diameter (D), the surface roughness, the sphericity and the CV value of the spherical-shaped silica fine particles [5] are shown in Table 1.

### Example 1

### Manufacturing Example 1 of Toner

### (1) Manufacturing of Resin Particles for Core Portion [1]

Resin particles for core portion [1] having multi-layer structure were manufactured by first-stage polymerization, second-stage polymerization and third-stage polymerization as follows.

### (a) First-Stage Polymerization (Resin Particles [A1])

A surfactant solution, in which 4 parts by mass of polyoxyethylene-2-dodecyl ether sodium sulfate was dissolved in 3,040 parts by mass of ion exchanged water, was fed in a 5 L reaction chamber equipped with a stirrer, a temperature sensor, a condenser tube and a nitrogen introduction device. While the mixture was being stirred at a stirring speed of 230 rpm in nitrogen gas flow, its internal temperature was raised to 80° C. To this surfactant solution, a polymerization initiator solution, in which 10 parts by mass of polymerization initiator (potassium persulfate: KPS) was dissolved in 400 parts by mass of the ion exchanged water, was added, and the temperature was changed to 75° C. Thereafter, a monomer mixture formed by 532 parts by mass of styrene, 200 parts by mass of n-butyl acrylate, 68 parts by mass of methacrylic acid and 16.4 parts by mass of n-octyl mercaptan was dropped thereto over one hour, and the system was heated and stirred at 75° C. over two hours for polymerization (first-stage polymerization), to form resin particles [A1]. It should be noted that a weight-average molecular weight (Mw) of the resin particles [A1] manufactured by the first-stage polymerization was 16,500.

The measurement of the weight-average molecular weight (Mw) was made by “HLC-8220” (manufactured by Tosoh Corporation) and a column “TSK guard column+TSK gel Super HZM-M3 Ren” (manufactured by Tosoh Corporation). While maintaining the column temperature at 40° C., tetrahydrofuran (THF) was made to flow as a carrier solvent at a flow velocity of 0.2 ml/min. A measurement sample was dissolved in tetrahydrofuran under dissolving conditions to perform dissolving treatment using an ultrasonic dispersion device at the room temperature for five minutes, so that its concentration would become 1 mg/ml. Then, it was subjected to a membrane filter having a pore size of 0.2 μm, to obtain a sample solution. 10 μl of this sample solution was injected in the apparatus together with the above-described carrier solvent, and detected using a refractive index detector (RI detector), to calculate molecular weight distribution of the measurement sample using a calibration curve measured by using monodispersed polystyrene standard particles. Those having a molecular weight of 6×10², 2.1×10³, 4×10³, 1.75×10⁴, 5.1×10⁴, 1.1×10⁵, 3.9×10⁶, 8.6×10⁵, 2×10⁶ and 4.48×10⁶ manufactured by Pressure Chemical Company were used as the standard polystyrene sample for measuring the calibration curve. At least about ten standard polystyrene samples were measured to make the calibration curve. Further, the refractive index detector was used as the detector.

### (b) Second-Stage Polymerization (Resin Particles [A2]: Formation of Intermediate Layer)

In a flask equipped with a stirrer, 93.8 parts by mass of a paraffin wax “HNP-57” (manufactured by Nippon Seiro Co., Ltd.) was added as a release agent to a monomer mixture formed by 101.1 parts by mass of styrene, 62.2 parts by mass of n-butyl acrylate, 12.3 parts by mass of methacrylic acid and 1.75 parts by mass of n-octyl mercaptan, which were heated to 90° C. for dissolution.

Meanwhile, a surfactant solution, in which 3 parts by mass of polyoxyethylene-2-dodecyl ether sodium sulfate was dissolved in 1,560 parts by mass of the ion exchanged water, was heated to 98° C. 32.8 parts by mass (in terms of a solid content) of the above-described resin particles [A1] was added to this surfactant solution, and the above-described monomer solution containing the paraffin wax was mixed thereto and dispersed therein for eight hours by a mechanical dispersion machine “Clearmix” (manufactured by M Technique Co., Ltd.) having a circulation path, to prepare a dispersion liquid including emulsion particles having a dispersion particle diameter of 340 nm. Next, a polymerization initiator solution, in which 6 parts by mass of the potassium persulfate was dissolved in 200 parts by mass of the ion exchanged water, was added to this emulsion particle dispersion liquid, and the system was heated and stirred at 98° C. over 12 hours for polymerization (second-stage polymerization), to form resin particles [A2]. It should be noted that the weight-average molecular weight (Mw) of the resin particles [A2] prepared in the second-stage polymerization was 23,000.

### (c) Third-Stage Polymerization (Resin Particles for Core Portion [1]: Formation of Outer Layer)

A polymerization initiator solution, in which 5.45 parts by mass of potassium persulfate was dissolved in 220 parts by mass of the ion exchanged water, was added to the above-described resin particles [A2] and, under the temperature condition of 80° C., a monomer mixture formed by 293.8 parts by mass of styrene, 154.1 parts by mass of n-butyl acrylate and 7.08 parts by mass of n-octyl mercaptan was dropped over one hour. After the dropping, it was heated and stirred over two hours for polymerization (third-stage polymerization), and then cooled to 28° C., to obtain resin particles for core portion [1]. It should, be noted that Mw of the resin particles for core portion [1] was 26,800. Further, a volume average particle diameter of the resin particles for core portion [1] was 125 nm. Furthermore, the glass transition point (Tg) of the resin particles for core portion [1] was 28.1° C.

### (2) Manufacturing of Resin Particles for Shell Layer [1]

The polymerization reaction and the treatment after the reaction were performed in the same manner as the above-described first-stage polymerization of the resin particles for core portion [1], except that the monomer mixture to be used was changed to include 548 parts by mass of styrene, 156 parts by mass 2-ethylhexyl acrylate, 96 parts by mass of methacrylic acid and 16.5 parts by mass of n-octyl mercaptan, to form resin particles for shell layer [1]. It should be noted that the glass transition point (Tg) of the resin particles for shell layer [1] was 53.0° C.

### (2) Preparation of Colorant Fine Particle Dispersion Liquid

90 parts by mass of sodium dodecyl sulfate was added to 1,600 parts by mass of the ion exchanged water. While stirring this solution, 420 parts by mass of carbon black “Regal 330R” (manufactured by Cabot Corporation) was gradually added thereto, and the solution was subjected to dispersion treatment by using a stirrer “Clearmix” (manufactured by M Technique Co., Ltd.), to prepare a colorant fine particle dispersion liquid [1] in which colorant fine particles were dispersed.

The particle diameter of the colorant fine particles in this colorant fine particle dispersion liquid [1] measured by using an electrophoretic light scattering photometer “ELS-800” (manufactured by Otsuka Electronics Co., Ltd.) was 110 nm.

### (3) Manufacturing of Toner Particles

### (a) Formation of Core Portion

420 parts by mass (in terms of a solid content) of the resin particles for core portion [1], 900 parts by mass of the ion exchanged water and 100 parts by mass of the colorant fine particle dispersion liquid [1] were fed in a reaction chamber equipped with a temperature sensor, a condenser tube, a nitrogen introduction device and a stirrer for stirring. After adjusting the temperature inside the reaction chamber to 30° C., 5 mol/L of aqueous sodium hydroxide was added to this solution, so that the pH was adjusted to 8 to 11.

Next, an aqueous solution, in which 60 parts by mass of magnesium chloride hexahydrate was dissolved in 60 parts by mass of the ion exchanged water, was added thereto at 30° C. over 10 minutes, while being stirred. After it was allowed to stand for three minutes, heating of the system was started until its temperature reached 80° C. (formation temperature of the core portion) over 80 minutes. In this state, the particle diameter of the particles was measured by “Coulter Multisizer 3” (manufactured by Beckman Coulter, Inc.). When the volume-based median diameter of the particles (D₅₀) became 6.3 μm, an aqueous solution, in which 40.2 parts by mass of sodium chloride was dissolved in 1,000 parts by mass of the ion exchanged water, was added thereto to stop particle diameter growth. Further, as aging treatment, it was heated and stirred at the liquid temperature of 80° C. (formation temperature of the core portion) over one hour to continue fusing, thus forming the core portion [1]. The circularity of the core portion [1] measured, by “FPIA-2100” (manufactured by Sysmex Corporation) was 0.930. Further, an electron emission type scanning electron microscope “JSM-7401F” (manufactured by JEOL Ltd.) was used to examine the core portion [1] at 10,000 magnification by scanning transmission electron microscopy, and it was confirmed that the colorant was dissolved in the binder resin and that no dispersed fine particles of the colorant was left.

### (b) Formation of Shell Layer

Next, 46.8 parts by mass (in terms of a solid content) of the resin particles for shell layer [1] was added thereto at 65° C., and an aqueous solution, in which 2 parts by mass of magnesium chloride hexahydrate was dissolved in 60 parts by mass of the ion exchanged water, was added thereto over 10 minutes. Thereafter, it was heated to 80° C. (forming temperature of the shell), and stirred over one hour, to fuse the particles of the resin particles for shell layer [1] to the surface of the core portion [1]. Then, it was subjected to the aging treatment at 80° C. (aging temperature of the shell) until the predetermined circularity was obtained, to form the shell layer. Here, after an aqueous solution, in which 40.2 parts by mass of sodium chloride was dissolved in 1,000 parts by mass of the ion exchanged water, was added thereto, it was cooled to 30° C. under the condition of 8° C./minute. The generated fuse particles were filtered, repeatedly cleaned by the ion exchanged water at 45° C., and thereafter dried by warm air of 40° C., so as to obtain toner particles [1] having the shell layer on the surface of the core portion, the volume-based median diameter (D₅₀) of 6.5 μm and the glass transition point (Tg) of 31° C.

### (4) Addition of External Additives

2.5 mass % of the above-described specifically-shaped silica fine particles [1], 1.0 mass % of hydrophobic silica (number average primary particle diameter=12 nm) and 0.6 mass % of hydrophobic titania (number average primary particle diameter=20 nm) were added to the dried toner particles [1], which were mixed using a Henschel mixer “FM10B” (manufactured by Mitsui Miike Kako K.K.) for 10 minutes at a circumferential velocity of a stirring blade of 40 m/second and at treatment temperature of 30° C. Thereafter, coarse particles were removed by using a sieve having an opening of 90 μm, to manufacture a toner [1].

### Examples 2 to 4

### Comparative Example 1

### Manufacturing Examples 2 to 5 of Toner

Toners [2] to [5] were obtained in the same manner as the manufacturing example 1 of the toner, except that the specifically-shaped silica fine particles [1] added in the adding step of the external additives were changed to the respective specifically-shaped silica fine particles [2] to [4] and the spherical-shaped silica fine particles [5].

### Manufacturing Examples 1 to 5 of Developer

A ferrite carrier coated with a silicone resin and having a volume-based median diameter of 35 μm was mixed with each of the toners [1] to [5] so that the concentration of the toners would become 7.5 mass %, to thereby manufacture developers [1] to [5].

### Manufacturing Example 1 of Organic Photosensitive Element

### (1) Manufacturing of Conductive Support

The surface of a drum-shaped aluminum support was subjected to machining to manufacture a conductive support [1] having surface roughness Rz=1.5 (μm).

### (2) Forming Step of Intermediate Layer

The following materials were dispersed in a batchwise manner for 10 hours by using a sand mill as a dispersion device, to prepare a coating liquid for forming intermediate layer [1].

| | | |
|---|---|---|
| Binder resin: polyamide resin “X1010” | 1 | part by mass |
| (manufactured by Daicel-degussa Ltd.) | | |
| Solvent: ethanol | 20 | parts by mass |
| Metal oxide fine particles: titanium oxide fine | 1.1 | parts by mass |
| particles having the number average primary particle | | |
| diameter of 0.035 μm “SMT500SAS” | | |
| (manufactured by Tayca Corporation) | | |

This coating liquid for forming intermediate layer [1] was applied onto the above-described conductive support [1] by a dip-coating method, to form a coating film. This coating film was dried at 110° C. for 20 minutes, to form an intermediate layer [1] having the film thickness of 2 μm.

### (3) Forming Step of Organic Photosensitive Layer

### (Forming Step of Charge Generation Layer)

The following materials were dispersed for 10 hours by using a sand mill as the dispersion device, to prepare a coating liquid for forming charge generation layer [1].

| | |
|---|---|
| Charge generating substance: titanyl phtalocyanine | 20 parts by mass |
| pigment (having a maximum diffraction peak at least | |
| at 27.3° by Cu-Kα characteristic X-ray diffraction | |
| spectrum measurement) | |
| Binder resin: polyvinyl butyral resin “#6000-C” | 10 parts by mass |
| (manufactured by Denki Kagaku Kogyo Kabushiki | |
| Kaisha) | |
| Solvent: t-butyl acrylate | 700 parts by mass |
| Solvent: 4-methoxy-4-methyl-2-pentanone | 300 parts by mass |

The coating liquid for forming charge generation layer [1] was applied on the above-described intermediate layer [1] by the dip-coating method to form a coating film, thus forming the charge generation layer [1] having the film thickness of 0.3 μm.

### (Forming Step of Charge Transport Layer)

The following materials were mixed and dissolved to prepare a coating liquid for forming charge transport layer [1].

| | | |
|---|---|---|
| Charge transport substance: compound shown | 150 | parts by mass |
| by a following formula (A) | | |
| Binder resin: polycarbonate resin “Z300” | 300 | parts by mass |
| (manufactured by Mitsubishi Gas Chemical | | |
| Company, Inc.) | | |
| Solvent: toluene/tetrahydrofuran = 1/9 volume % | 2,000 | parts by mass |
| Antioxidant: “Irganox1010” (manufactured by | 6 | parts by mass |
| Nihon Ciba-Geigy K.K.) | | |
| Leveling agent: silicone oil “KF-54” | 1 | part by mass |
| (manufactured by Shin-Etsu Chemical Co., Ltd.) | | |

The coating liquid for forming charge transport layer [1] was applied on the above-described charge generation layer [1] by the dip-coating method to form a coating film, and the coating film was dried at 110° C. for 60 minutes, to form a charge transport layer [1] having the film thickness of 20 μm.

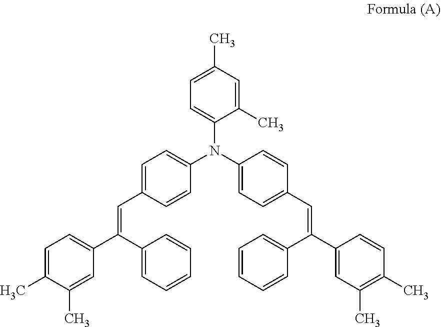

### (4) Forming Step of Protective Layer

Polymerizable compound: compound shown by a following formula (B) 100 parts by mass

Solvent: isopropyl alcohol 500 parts by mass

Metal oxide fine particles: titanium oxide fine particles subjected to the surface treatment by a surface treatment agent [CH₂═C(CH₃)COO(CH₂)₂Si(OCH₃)₃] and having the number average primary particle diameter of 6 nm 100 parts by mass

The above polymerizable compound, solvent and metal oxide fine particles were dispersed for 10 hours by using a sand mill as the dispersion device under light-shielded condition. After that, the following was added thereto.

Polymerization initiator: “Irgacure 369” (manufactured by BASF Japan Ltd.) 30 parts by mass

Then, it was mixed and stirred under the light-shielded condition, to prepare a coating liquid for forming protective layer [1].

This coating liquid for forming protective layer [1] was applied onto the above-described charge transport layer [1] by using a circular slide hopper coating machine as shown in FIG. 3, to form a coating film. Thereafter, this coating film was dried at the room temperature for 20 minutes, and irradiated with ultraviolet rays by using a metal halide lamp (500 W) for one minute in nitrogen gas flow, while rotating the photosensitive element and leaving a space distance between a light source and the surface of the photosensitive element of 100 mm, to form a protective layer [1] having the film thickness of 3 μm. This is regarded as an organic photosensitive element [1].

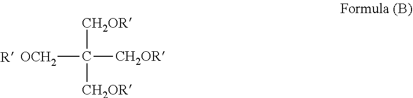

[wherein R′ is a methacryloyl group.]

In a modified apparatus of a color image forming apparatus “bizhub PRO C6500” (manufactured by Konica Minolta Business Technologies, Inc.), in which the above-described organic photosensitive element [1] was installed, the developers [1] to [5] were sequentially loaded. Under the environment of an ordinary temperature of 20° C. and ordinary relative humidity of 50%, 200,000 copies of an image with a pixel rate of 1% (an original image having a character image of 7%, a photograph of a person's face, a solid white image and a solid black image in each quarter) were made on A4-sized fine papers (64 g/m²), and a copy of a solid black image was made lastly.

### (1) Fogging

First, a white paper density was calculated by measuring and averaging an absolute image density at 20 points of a white paper before forming the image, using a Macbeth reflection densitometer “RD-918”.

Next, an average density was similarly calculated by measuring and averaging the absolute image density at 20 points of a white area in 50,000th and 60,000th images. A value subtracting the white paper density from this average density was evaluated as a fogging density. When the fogging density was 0.008 or lower, it was regarded as practically usable. The results are shown in Table 1.

### (2) Filming

The lastly-formed solid black image was examined visually, and evaluated on the basis of the following evaluation criteria. “A” and “B” were determined to be acceptable. The results are shown in Table 1.

### —Evaluation Criteria—

A: No white stripes can be found on the solid black image.
B: Some striped parts with a slightly reduced density can be found on the solid black image.
C: White stripes can be clearly found on the solid black image.

TABLE 1

| | | SILICA FINE PARTICLES | | | | | | | |
|---|---|---|---|---|---|---|---|---|---|
| | | | | | | | CV | EVALUATION | |
| | TONER | | | SURFACE | | D | VALUE | RESULTS | |
| | NO. | NO. | SHAPE | ROUGHNESS | SPHERICITY | (nm) | (%) | FOGGING | FILMING |
| EXAMPLE 1 | 1 | 1 | SPECIFICALLY- | 3.0 | 1.1 | 120 | 17 | 0.004 | A |
| | | | SHAPED | | | | | | |
| EXAMPLE 2 | 2 | 2 | SPECIFICALLY- | 3.3 | 1.2 | 80 | 15 | 0.005 | A |
| | | | SHAPED | | | | | | |
| EXAMPLE 3 | 3 | 3 | SPECIFICALLY- | 2.2 | 1.2 | 200 | 20 | 0.006 | A |
| | | | SHAPED | | | | | | |
| COMPARATIVE | 4 | 4 | SPECIFICALLY- | 2.0 | 1.1 | 20 | 25 | 0.010 | C |
| EXAMPLE 1 | | | SHAPED | | | | | | |
| COMPARATIVE | 5 | 5 | SPHERICAL- | 1.4 | 1.1 | 120 | 17 | 0.007 | C |
| EXAMPLE 2 | | | SHAPED | | | | | | |

 SPECIFICALLY-SHAPED = SHAPE WITH A NUMBER OF PROJECTIONS COVERING SURFACE

10 toner image forming unit
11 charge means
12 exposure means
12A semiconductor laser beam source
12B polygon mirror
12C fθ lens
13 developing unit
14 transfer means
15 photosensitive element
16 separation means
17 precharge exposure means
19 cleaning means
19A cleaning blade
19B supporting member
19C rotation axis
19D load spring
20 fixing device
21, 22 heating and pressurizing roller
N nip
P transfer material
R transfer region

1. A toner for electrostatic image development, comprising toner particles and an external additive, wherein
the external additive includes silica fine particles whose surface is covered with a number of projections, and a number average particle diameter of the silica fine particles is 80 to 200 nm.

2. The toner for electrostatic image development according to claim 1, wherein the silica fine particles whose surface is covered with a number of projections has surface roughness of 1.9 to 4.0.

3. The toner for electrostatic image development according to claim 1, wherein the external additive includes small-diameter fine particles for external additive having a number average particle diameter of 5 to 45 nm.

4. The toner for electrostatic image development according to claim 3, wherein the small-diameter fine particles for external additive are titania.

5. The toner for electrostatic image development according to claim 3, wherein the small-diameter fine particles for external additive are titania and silica

6. The toner for electrostatic image development according to claim 1, wherein an addition amount of the silica fine particles whose surface is covered with a number of projections is 0.5 to 4 parts by mass per 100 parts by mass of toner particles.

7. The toner for electrostatic image development according to claim 3, wherein an addition amount of the small-diameter fine particles for external additive is 0.1 to 5 parts by mass per 100 parts by mass of toner particles.

8. The toner for electrostatic image development according to claim 3, wherein a mass ratio between the silica fine particles whose surface is covered with a number of projections and the small-diameter fine particles for external additive (the silica fine particles whose surface is covered with a number of projections/the small-diameter fine particles for external additive) is 3/0.3 to 0.3/3.

9. The toner for electrostatic image development according to claim 1, wherein sphericity SF-1 of the silica fine particles whose surface is covered with a number of projections is 1.1 to 1.3.

10. An image forming method comprising: a toner image forming step of forming a toner image by developing an electrostatic latent image formed on an image carrier by a toner; a transferring step of transferring the toner image formed on the image carrier to a transfer material; and a cleaning step of removing the toner remaining on the image carrier after the transferring step by a cleaning blade provided with its tip coming in contact with the image carrier, wherein
the toner for electrostatic image development according to claim 1 is used as the toner.

11. The image forming method according to claim 10, wherein
the image carrier comprises an organic photosensitive element formed by laminating an organic photosensitive layer and a protective layer made of a cured resin on a conductive support in this order, wherein
the protective layer is obtained by curing a coating film of a coating liquid for forming protective layer that contains a polymerizable compound to form the cured resin constituting the protective layer and fine particles of a metal oxide.
